(19) United States
(12) Patent Application Publication
(10) Pub. No.: US 2026/0259309 A1
(43) Pub. Date: Sep. 3, 2026

(54) METHOD AND SYSTEM FOR GENERATING MILLIMETER-WAVE FRAMES

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: Takeshi KONDO, Nisshin-shi (JP)

(21) Appl. No.: 19/538,078

(22) Filed: Feb. 12, 2026

(30) Foreign Application Priority Data
Mar. 3, 2025 (JP) 2025-032534

(51) Int. Cl. G01S 13/34; G01S 7/41; G01S 13/58

(52) U.S. Cl. CPC G01S 13/343; G01S 7/418; G01S 13/584

(57) ABSTRACT

A method of generating millimeter-wave frames from beat signals of a millimeter-wave radar is provided. The method includes generating a first millimeter-wave frame based on a first set of the beat signals, and then generating a second millimeter-wave frame based on a part of the first set of the beat signals and a second set of the beat signals produced after production of the first set of the beat signals.

### CROSS REFERENCE TO RELATED APPLICATION

The present application claims the benefit of priority from Japanese Patent Application No. 2025-032534 filed on March 3, 2025. The entire disclosure of the above application is incorporated herein by reference.

### TECHNICAL FIELD

The present disclosure relates to a technique for generating millimeter-wave frames from received signals of a millimeter-wave radar.

### BACKGROUND ART

There is a technique for detecting an object using a millimeter-wave radar. In recent years, techniques that fuse detection results from a millimeter-wave radar with detection results from other sensors, such as cameras, to detect objects have been utilized.

### SUMMARY

According to one embodiment of the present disclosure, a method for generating millimeter-wave frames from beat signals of a millimeter-wave radar is provided. The method may include generating a first millimeter-wave frame based on a first set of the beat signals, and then generating a second millimeter-wave frame based on a part of the first set of the beat signals and a second set of the beat signals produced after production of the first set of the beat signals.

### BRIEF DESCRIPTION OF DRAWINGS

FIG. 1 is a block diagram showing the configuration of an object detection system.

FIG. 2 is a block diagram showing the configuration of a millimeter-wave radar and a millimeter-wave signal processing unit.

FIG. 3A is an explanatory diagram showing various signals of a typical millimeter-wave radar.

FIG. 3B is an explanatory diagram showing chirp signals.

FIG. 3C is an explanatory diagram showing a millimeter-wave frame.

FIG. 4 is an explanatory diagram showing the timing of millimeter-wave frames and image frames in a comparative example.

FIG. 5 is an explanatory diagram showing the timing of millimeter-wave frames and image frames in an embodiment.

FIG. 6 is an explanatory diagram showing a method of setting a readout address of a memory.

FIG. 7 is an explanatory diagram showing a method of setting a readout address to return from the beginning to the end of a memory.

### DESCRIPTION OF EMBODIMENTS

To begin with, examples of relevant techniques will be described.

There is a technique for detecting an object using a millimeter-wave radar. In recent years, techniques that fuse detection results from a millimeter-wave radar with detection results from other sensors, such as cameras, to detect objects have been utilized.

However, the fusion may not be performed at an appropriate timing since the generation timing of millimeter-wave frames and image frames does not always coincide. The problem of being unable to generate millimeter-wave frames at appropriate timing may also arise even when fusion with other sensors, such as cameras, is not performed.

According to one embodiment of the present disclosure, a method for generating millimeter-wave frames from beat signals of a millimeter-wave radar is provided. The method includes generating a first millimeter-wave frame based on a first set of the beat signals, and then generating a second millimeter-wave frame based on a part of the first set of the beat signals and a second set of the beat signals produced after production of the first set of the beat signals.

According to this method, each millimeter-wave frame is generated so that the preceding millimeter wave frame and the subsequent millimeter wave frame partially overlap. Thus, millimeter-wave frames can be generated at appropriate timings.

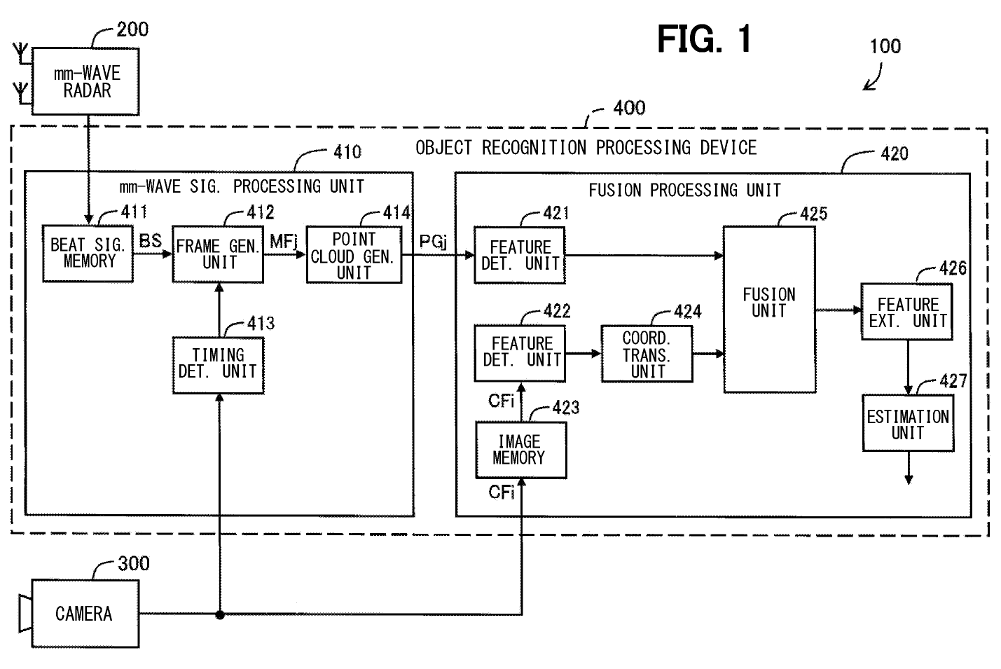

As shown in FIG. 1, an object detection system 100 includes a millimeter-wave radar 200, a camera 300, and an object recognition processing device 400. The object recognition processing device 400 includes a millimeter-wave signal processing unit 410 and a fusion processing unit 420.

The millimeter-wave signal processing unit 410 includes a beat signal memory 411, a frame generation unit 412, a timing detection unit 413, and a point cloud generation unit 414. The beat signal memory 411 temporarily stores beat signals BS generated by the millimeter-wave radar 200. The frame generation unit 412 reads out the beat signals BS stored in the beat signal memory 411 and generates a millimeter-wave frame MFj. Here, j is an ordinal number. The timing detection unit 413 generates a timing for creating the millimeter-wave frame MFj in synchronization with a specific timing signal provided from an external device, namely the camera 300, and notifies the frame generation unit 412 of this timing. The "specific timing signal" may be a signal indicating the end timing of an image frame. The point cloud generation unit 414 generates a point cloud from the millimeter-wave frame MFj generated by the frame generation unit 412.

The fusion processing unit 420 includes a feature detection unit 421 for millimeter-wave frames, a feature detection unit 422 for image frames, an image memory 423, a coordinate transformation unit 424, a fusion unit 425, a feature extraction unit 426, and an estimation unit 427.

The feature detection unit 421 for millimeter-wave frames detects feature quantities of the point cloud generated by the point cloud generation unit 414. The feature detection unit 422 for image frames detects feature quantities of image frame CFi stored in the image memory 423. Here, i is an ordinal number. The image memory 423 stores the image frame CFi captured by the camera 300. The coordinate transformation unit 424 executes coordinate transformation of the feature quantities detected from the image frame CFi. This coordinate transformation is a process of estimating the depth direction in the image frame CFi and transforming the coordinates of the image frame CFi to BEV (Bird’s Eye View) coordinates. As a result, the image frame CFi is transformed into information on a horizontal plane. The fusion unit 425 executes the fusion of feature quantities detected from the millimeter-wave frame MFj and feature quantities detected from the image frame CFi. The feature extraction unit 426 further extracts feature quantities from the fused feature quantities. The estimation unit 427 uses the feature quantities extracted by the feature extraction unit 426 to estimate the position and shape of objects (i.e., targets) such as people or vehicles.

The object recognition processing device 400 may be configured as a microcontroller including a memory and a processor. Various functions of the microcontroller are realized by executing a computer program stored in the memory. Additionally, some or all of the functions executed by the processor may be implemented by hardware circuits.

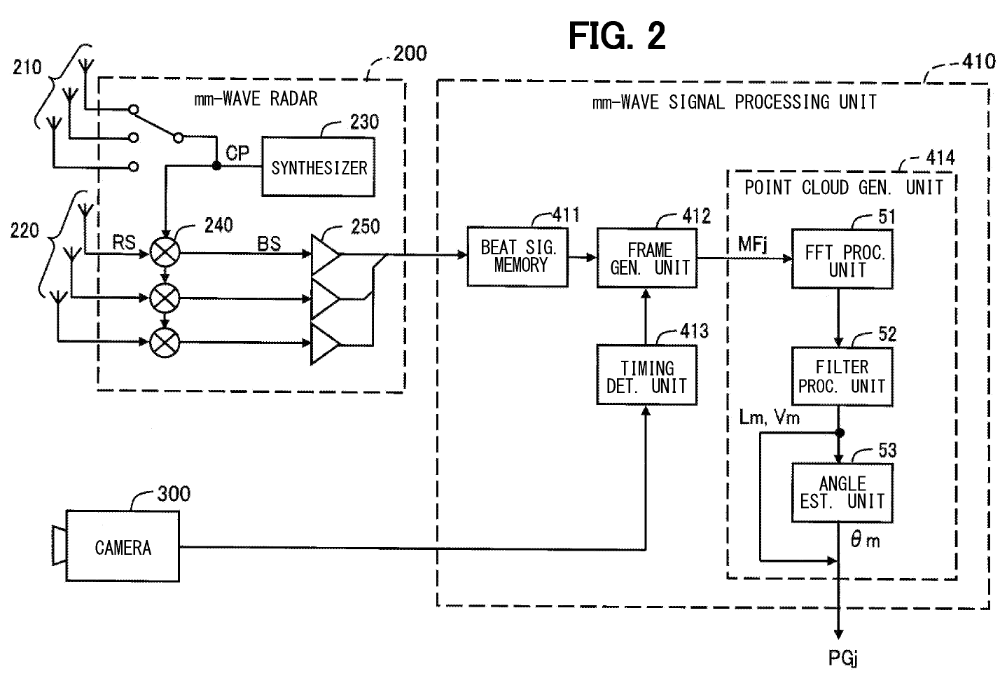

As shown in FIG. 2, the millimeter-wave radar 200 includes K transmission antennas 210, N reception antennas 220, a synthesizer 230, multiple mixers 240, and multiple A/D converters 250. K and N are each integers of 2 or greater.

The millimeter-wave radar 200 of the present embodiment is configured as a MIMO (Multiple-Input Multiple-Output) radar. However, the present disclosure is also applicable to a SIMO (Single-Input Multiple-Output) radar in which the number K of transmission antennas 210 is one.

The synthesizer 230 generates chirp signals CP that vary the frequency of carrier wave over time. The mixers 240 mix received signals RS from the reception antennas 220 with the chirp signals CP from the synthesizer 230, and generates beat signals BS that represent the frequency difference between the chirp signals CP and the received signals RS. The A/D converters 250 convert the beat signals BS into digital signals. The beat signals after A/D conversion are sequentially written into the beat signal memory 411.

The frame generation unit 412 reads out the beat signals BS stored in the beat signal memory 411 in accordance with externally provided timing, and generates a millimeter-wave frame MFj. In the present embodiment, the millimeter-wave frame MFj is generated in synchronization with the generation timing of image frame CFi by the camera 300. Specifically, the generation timing of the millimeter-wave frame MFj is adjusted so that the generation of the millimeter-wave frame MFj is completed in synchronization with the completion of the generation of the image frame CFi by the camera 300. This will be described later. However, the millimeter-wave frame MFj may be generated at periodic timing without receiving timing signals from an external device.

The point cloud generation unit 414 includes an FFT processing unit 51 that performs FFT (Fast Fourier Transform) processing on the millimeter-wave frame MFj, a filter processing unit 52 that performs filter processing, and an angle estimation unit 53. The filter processing unit 52 determines the distance Lm and speed Vm of an object through filter processing. The angle estimation unit 53 determines the angle θm of the object. As a result, the point cloud generation unit 414 can generate a point cloud PG that includes information on the distance Lm, speed Vm, and angle θm of the object.

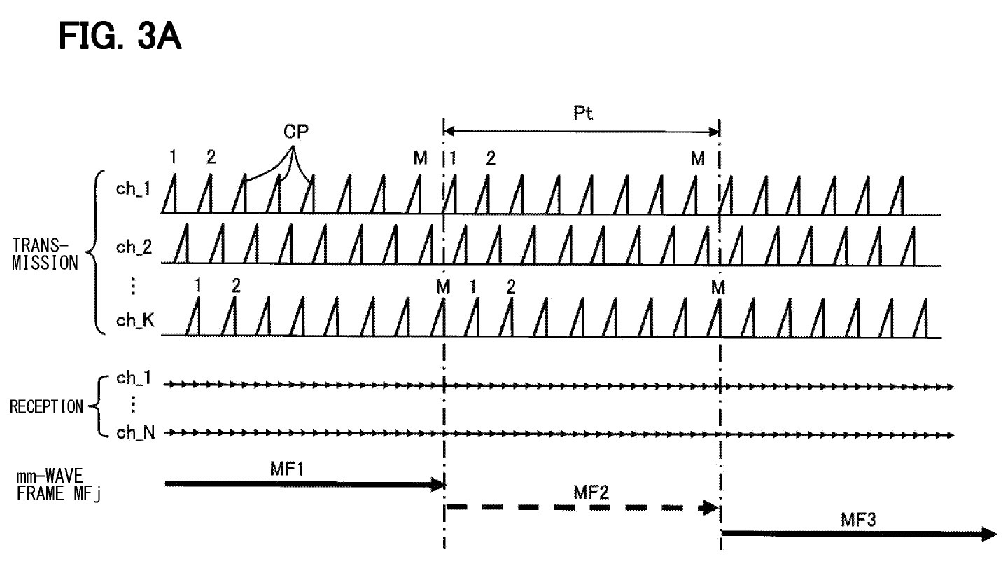

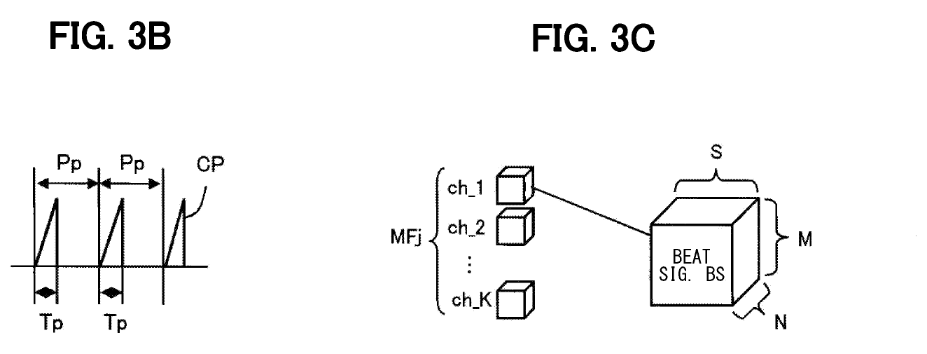

As shown in FIG. 3A, each of the K transmission antennas 210 transmits M chirp signals CP during each transmission period Pt. M is an integer of 2 or greater. The present embodiment may use a Fast Chirp Modulation (FCM) method in which only the up-sweeping phase is repeated. The up-sweeping phase is a phase in which the frequency is increased. However, the present disclosure is also applicable to an FCM method in which only the down-sweeping phase is repeated, as well as to an FMCW (Frequency Modulated Continuous Wave) method in which the frequency is varied in both the up-sweeping and down-sweeping phases. In the present embodiment, according to the TDM (Time Division Multiplex) method, the chirp signals CP are allocated to the K transmission antennas 210 in a time-division manner. As a result, K × M chirp signals CP are transmitted during each transmission period Pt. As shown in FIG. 3B, each of the chirp signals CP has a chirp period Pp and a chirp duration Tp. The chirp duration Tp is the period during which the chirp signal CP is generated. The chirp period Pp may be set to K times the chirp duration Tp.

The received signals RS received by the N reception antennas 220 are mixed with the chirp signals CP, thereby generating beat signals BS. Similar to the chirp signal CP, K × M × N beat signals BS are generated for each transmission period Pt. These beat signals BS are converted by A/D conversion and temporarily stored in the beat signal memory 411, and are read out in order to generate a millimeter-wave frame MFj. Assuming that each beat signal BS is sampled S times during A/D conversion, the millimeter-wave frame MFj contains S × K × M × N beat signal values. S is an integer equal to or greater than 2. For example, as shown in FIG. 3C, one millimeter-wave frame MFj is composed of K sets of data each including S × M × N beat signals BS, corresponding to the K transmission antennas 210.

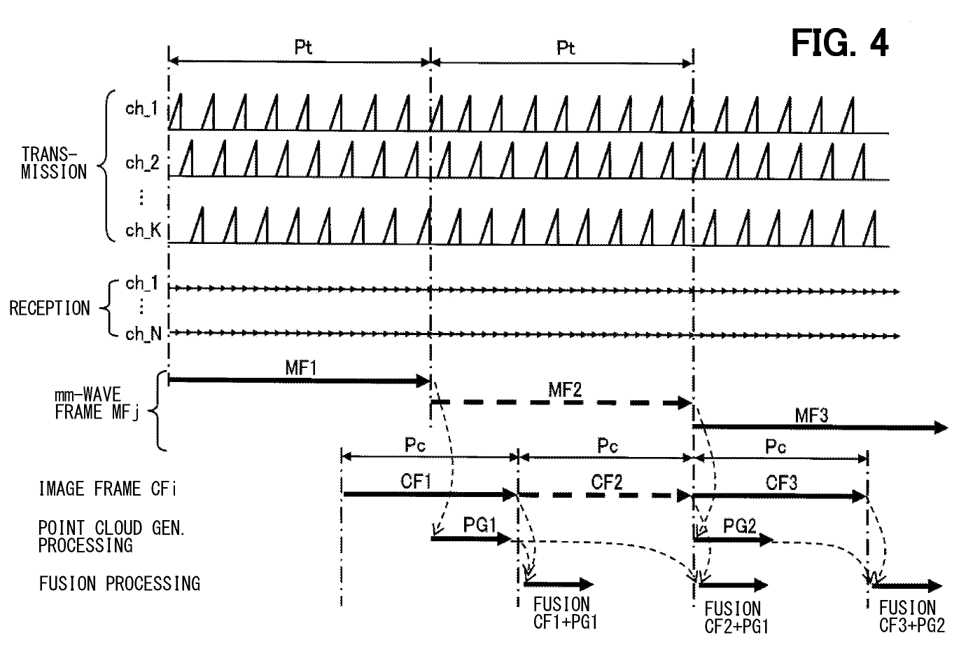

In the comparative example shown in FIG. 4, the millimeter-wave frame MFj and the image frame CFi are each generated at their respective timings without mutually adjusting the timing of their generation. That is, the millimeter-wave frame MFj is generated at each transmission period Pt of the millimeter-wave radar 200, and the image frame CFi is generated at each shutter period Pc of the camera 300. The shutter period Pc of the camera 300 is set shorter than the transmission period Pt of the millimeter-wave radar 200. The point cloud generation processing by the millimeter-wave signal processing unit 410 starts immediately after each millimeter-wave frame MFj is generated, resulting in the generation of point cloud PGj.

The fusion processing by the fusion processing unit 420 starts after the completion of a single image frame CFi, and is executed using the point cloud PGj from the latest millimeter-wave frame MFjavailable at that time. For example, when the first image frame CF1 is completed, the point cloud PG1 from the first millimeter-wave frame MF1 is available, so the first image frame CF1 and the point cloud PG1 from the first millimeter-wave frame MF1 are subject to fusion. Additionally, when the second image frame CF2 is completed, the point cloud PG2 from the second millimeter-wave frame MF2 has not yet been generated, so the second image frame CF2 and the point cloud PG1 from the first millimeter-wave frame MF1 are subject to fusion. Similarly, when the third image frame CF3 is completed, the third image frame CF3 and the point cloud PG2 from the second millimeter-wave frame MF2 are subject to fusion.

In this manner, in the comparative example, there may be cases where data synchronization between the millimeter-wave frame MFj and the image frame CFi is significantly misaligned. That is, there may be cases where the fusion process is executed using a millimeter-wave frame MFj that is older in timing compared to the image frame CFi. As a result, when detecting a moving object, there is a possibility that the position of the object recognized from the millimeter-wave frame MFj and the position of the object recognized from the image frame CFi may be misaligned.

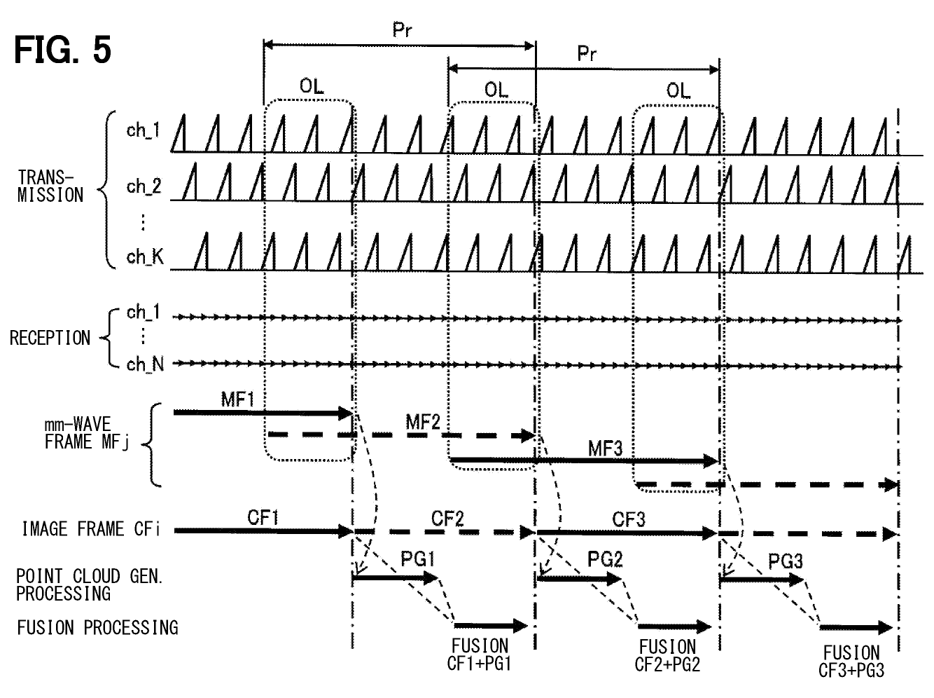

As shown in FIG. 5, in the present embodiment, the millimeter-wave frame receiving period Pr for each millimeter-wave frame MFj is adjusted so that the timing of the trailing edge of the image frame CFi coincides with the trailing edge of the millimeter-wave frame MFj. The “millimeter-wave frame receiving period Pr” refers to the period during which multiple received signals included in a single millimeter-wave frame MFj are received. The length of the millimeter-wave frame receiving period Pr is the same as the transmission period Pt described in FIG. 3. The period during which the image frame CFi is generated corresponds to the shutter open period of the camera 300. Normally, the shutter open period of the camera 300 exists within the period Pc of the image frame CFi. The period Pc of the image frame CFi, which includes the shutter open period of the camera 300, may be an integer multiple of the chirp period Pp of the millimeter-wave radar 200. By doing so, the timing accuracy between the image frame CFi and the millimeter-wave frame MFj can be improved.

The fusion process is initiated after the completion of the point cloud PGj of the millimeter-wave frame MFj, and is executed using the latest available image frame CFi at that time. For example, when the point cloud PG1 of the first millimeter-wave frame MF1 is completed, the first image frame CF1 is available, so the first image frame CF1 and the point cloud PG1 of the first millimeter-wave frame MF1 are subject to fusion. Similarly, when the point cloud PG2 of the second millimeter-wave frame MF2 is completed, the second image frame CF2 is available, so the second image frame CF2 and the point cloud PG2 of the second millimeter-wave frame MF2 are subject to fusion. When the point cloud PG3 of the third millimeter-wave frame MF3 is completed, the third image frame CF3 is available, so the third image frame CF3 and the point cloud PG3 of the third millimeter-wave frame MF3 are subject to fusion. As described above, in the present embodiment, the fusion process can be executed using the image frame CFi and the millimeter-wave frame MFj generated at synchronized timings. That is, the millimeter-wave frame MFj is generated in accordance with the generation timing of the image frame CFi to perform the fusion process between the image frame CFi and the millimeter-wave frame MFj. As a result, fusion of the detection results from the camera 300 and the millimeter-wave radar 200 can be executed at an appropriate timing.

The millimeter-wave frames MFj partially overlap with each other. That is, the subsequent millimeter-wave frame MFj+1 (the second millimeter-wave frame) is configured to include some of the beat signals BS (the first set of the beat signals) that constitute the preceding millimeter-wave frame MFj (the first millimeter-wave frame), as well as beat signals BS (the second set of the beat signals) that are generated after generation of the first set of the beat signals BS. The overlap part OL shown in FIG. 5 indicates the range of the beat signals BS that are included in both of two consecutive millimeter-wave frames MFj and MFj+1. As described above, in the present embodiment, each millimeter-wave frame is generated so that the preceding millimeter-wave frame MFj and the subsequent millimeter-wave frame MFj+1 partially overlap, thereby generating the millimeter-wave frames in accordance with appropriate timing.

In the example of FIG. 5, the timing of the trailing edge of the image frame CFi is matched with the trailing edge of the millimeter-wave frame MFj. Alternatively, the timing of the leading edge of the image frame CFi may be matched with the leading edge of the millimeter-wave frame MFj. Alternatively, the timing of the center of the image frame CFi may be matched with the timing of the center of the millimeter-wave frame MFj. As can be understood from the above descriptions, it is sufficient if the generation timing between the image frame CFi and the millimeter-wave frame MFj is adjusted so that the shutter open period for generating an image frame CFi is included within the millimeter-wave frame receiving period Pr of a millimeter-wave frame MFj. In this way, it is possible to synchronize the image frame CFi and the millimeter-wave frame MFj used in the fusion processing. When the method of matching the timing of the trailing edge of the image frame CFi and the trailing edge of the millimeter-wave frame MFj is adopted as shown in FIG. 5, the most recent data from both can be used, thereby improving processing accuracy.

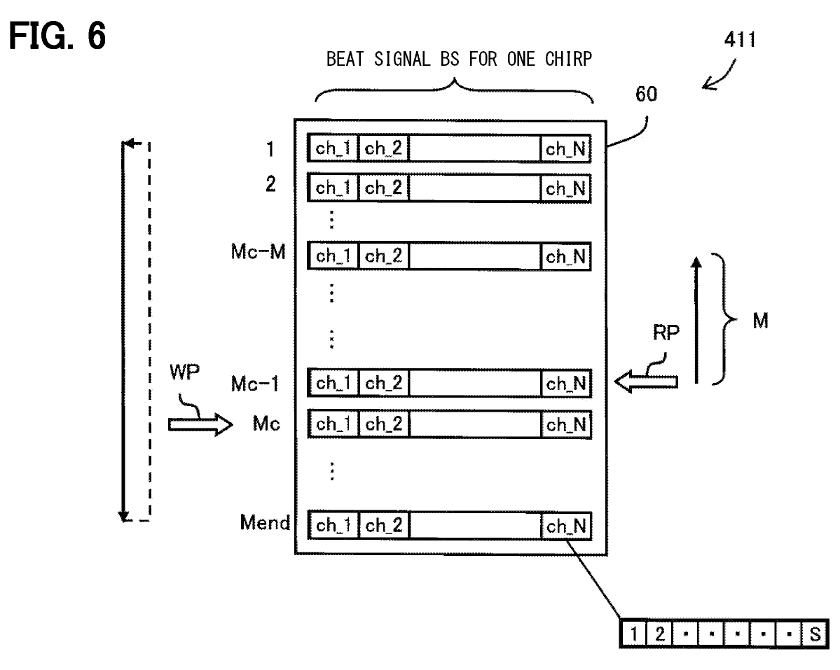

As shown in FIG. 6, the beat signal memory 411 has storage areas 60 each corresponding to a respective one of the transmission antennas 210. In each of the storage areas 60, one pointer is assigned for beat signals BS corresponding to one chirp. The beat signals BS for one chirp includes N beat signals BS corresponding to the N reception antennas 220. In addition, each individual beat signal BS contains S sampling results obtained through A/D conversion. Thus, at a memory location indicated by the pointer, N × S sampling results are stored. The beat signal memory 411 includes the K storage areas 60 corresponding to the K transmission antennas 210, as shown in FIG. 6.

When writing the beat signals BS, the write pointer WP changes so as to increment one by one from the starting position to the ending position of the storage area 60. In FIG. 6, the starting position of the storage area 60 is "1," and the ending position is "Mend." Furthermore, the write pointer WP repeatedly returns to the starting position when it reaches the ending position of the storage area 60. That is, the write pointer WP changes cyclically within the storage area 60 while incrementing.

When reading the beat signals BS, the read pointer RP changes so as to decrement one by one within the storage area 60. Furthermore, the read pointer RP repeatedly returns to the ending position when it reaches the starting position of the storage area 60. That is, the read pointer RP changes cyclically within the storage area 60 while decrementing.

In the example of FIG. 6, reading for generating one millimeter-wave frame MFj starts from the pointer position (Mc-1), which is one position before the latest write pointer position Mc, and is executed while decrementing the read pointer RP until reaching the M-th pointer position (Mc-M). As explained in FIG. 3A, M is the number of chirp signals CP transmitted from one transmission antenna 210 during the transmission period Pt.

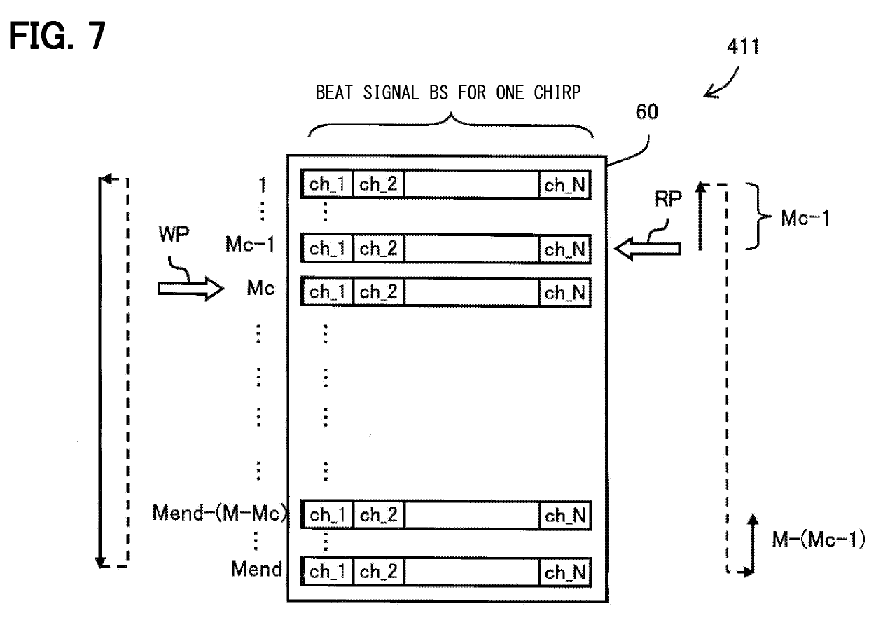

As shown in FIG. 7, when the latest write pointer position Mc is close to the starting position of the storage area 60, the beat signals BS read out may not reach the amount corresponding to M chirps even when the read pointer RP reaches the starting position. In this case, the read pointer RP moves to the rearmost pointer position Mend, and reading continues until the beat signals BS corresponding to M chirps are read out.

As shown in FIGS. 6 and 7, in this embodiment, within the storage area 60 of the beat signal memory 411, the write pointer WP is changed cyclically while being incremented, and the read pointer RP is changed cyclically while being decremented. As a result, it is possible to generate millimeter wave frames MFj by changing the read pointer RP and the write pointer WP.

As described above, according to this embodiment, a subsequent millimeter-wave frame MFj+1 is generated so as to include a portion of preceding beat signals constituting the preceding millimeter-wave frame MFj and subsequent beat signals generated after the preceding beat signals. That is, a millimeter wave frame is generated so that the preceding millimeter-wave frame MFj and the subsequent millimeter-wave frame MFj+1 partially overlap, thereby generating millimeter wave frames at appropriate timing.

The processing unit and its methods described in the present disclosure may be implemented by a dedicated computer, which is provided by configuring a processor and memory programmed to execute one or more functions embodied by a computer program. Alternatively, the processing unit and its methods described in the present disclosure may be implemented by a dedicated computer, which is provided by configuring a processor with one or more dedicated hardware logic circuits. Alternatively, the processing unit and its methods described in the present disclosure may be implemented by one or more dedicated computers configured by a combination of a processor and memory programmed to execute one or more functions and a processor configured with one or more hardware logic circuits. Furthermore, the computer program may be stored on a non-transitory computer-readable tangible recording medium as instructions executed by a computer.

The present disclosure is not limited to the above-mentioned embodiments or modifications thereof, but may be implemented in various forms without departing from the spirit thereof. Furthermore, the various characteristic configurations described above may be adopted in any combination as long as they are not mutually inconsistent.

In the present disclosure or the claims, the phrase "at least one of a circuit and a processor" should be interpreted disjunctively (logical OR) and should not be interpreted as at least one circuit and at least one processor. Therefore, in the present disclosure or the claim, "at least one of a circuit and a processor is configured to cause the object detection system to execute functions" includes the case where only the circuit causes the object detection system to execute all the functions. Additionally, "at least one of a circuit and a processor is configured to cause the object detection system to execute functions" includes the case where only the processor causes the object detection system to execute all the functions. Furthermore, "at least one of a circuit and a processor is configured to cause the object detection system to execute functions" includes the case where the circuit causes the object detection system to execute some of the functions and the processor causes the object detection system to execute the remaining functions. In the last case, for instance, if the object detection system executes functions A to C, functions A and B may be implemented by the circuit, and the remaining function C may be implemented by the processor.

What is claimed is:

1. A method of generating millimeter-wave frames from beat signals of a millimeter-wave radar, the method comprising:
generating a first millimeter-wave frame based on a first set of the beat signals; and then
generating a second millimeter-wave frame based on a part of the first set of the beat signals and a second set of the beat signals produced after production of the first set of the beat signals.

2. The method according to claim 1, further comprising:
(a) writing the beat signals to a memory; and
(b) reading out the beat signals from the memory in accordance with a start timing of the generating of the second millimeter-wave frame, wherein
the writing of the beat signals incudes incrementing and cyclically updating a write pointer of the memory within a memory area allocated for the beat signals, and
the reading out of the beat signals includes decrementing and cyclically updating a read pointer of the memory within the memory area.

3. The method according to claim 1, further comprising
determining a timing of starting generation of the second millimeter-wave frame based on a specified timing received from an external device.

4. The method according to claim 1, wherein
the millimeter-wave radar is configured to transmit chirp signals using a time-division method.

5. The method according to claim 1, wherein
the second millimeter-wave frame is generated in accordance with a generation timing of an image frame generated by a camera, for fusion processing between the second millimeter-wave frame and the image frame.

6. The method according to claim 5, wherein
a period of the image frame includes a shutter open period of the camera, and
the period of the image frame is an integer multiple of a chirp period of the millimeter-wave radar.

7. The method according to claim 5, wherein
a millimeter-wave frame receiving period is defined as a period during which multiple reception signals included in one of the millimeter-wave frames are received, and
the method further comprising:
adjusting a timing of the millimeter frame receiving period such that a shutter open period of the camera falls within the millimeter frame receiving period to generate the image frame.

8. An object detection system comprising:
a millimeter-wave radar; and
at least one of (i) a circuit and (ii) a processor with a memory storing computer program code executable by the processor, the at least one of the circuit and the processor configured to cause the object detection system to generate millimeter-wave frames from beat signals of the millimeter-wave radar, wherein
the at least one of the circuit and the processor is configured to generate:
a first millimeter-wave frame based on a first set of the beat signals; and then
a second millimeter-wave frame based on a part of the first set of the beat signals and a second set of the beat signals produced after production of the first set of the beat signals.
